(19) United States
(12) Patent Application Publication
(10) Pub. No.: US 2026/0008354 A1
(43) Pub. Date: Jan. 8, 2026

(54) MULTI-PHASE FULL-BRIDGE DRIVE SYSTEM AND METHOD FOR DRIVING MOTOR

(71) Applicant: XIANGFEI MENG, NANJING (CN)

(72) Inventor: XIANGFEI MENG, NANJING (CN)

(21) Appl. No.: 19/257,258

(22) Filed: Jul. 1, 2025

(30) Foreign Application Priority Data
Jul. 2, 2024 (CN) 2024108755732

(51) Int. Cl. B60L 15/08; B60L 3/00; H02M 7/5387

(52) U.S. Cl. CPC B60L 15/08; B60L 3/003; H02M 7/53871; B60L 2210/42; B60L 2240/526; B60L 2240/527; B60L 2240/529

(57) ABSTRACT

The present disclosure discloses a multi-phase full-bridge drive system and a method for driving a motor. The multi-phase full-bridge drive system for driving a motor includes: a multi-phase full-bridge circuit, comprising at least three identical half-bridge circuits, wherein each of the half-bridge circuits includes a first transistor and a second transistor, and switching loss of the first transistor is less than switching loss of the second transistor; and a controller used to control the multi-phase full-bridge circuit to generate target multi-phase drive voltages for driving the motor, wherein the controller is configured to select a half-bridge circuit from the at least three half-bridge circuits based on a power factor of the motor and the target multi-phase drive voltages, and reduce effective switching times of the second transistor of the selected half-bridge circuit. Furthermore, the present disclosure discloses a method for driving a motor.

### CROSS REFERENCE TO RELATED APPLICATION

This application claims the benefit of priority to Chinese Application No. 2024108755732, filed on Jul. 2, 2024, which is herein incorporated by reference.

### FIELD

The present disclosure relates to the field of power semiconductors and motor driving, and particularly, a multi-phase full-bridge drive system for driving a motor and a method for driving a motor.

### BACKGROUND

In the field of motor driving, a three-phase full-bridge circuit configured by power semiconductors is needed to convert a direct current (DC) and an alternating current (AC) with each other. The so-called three-phase full-bridge circuit is configured by three half-bridge circuits, and the so-called half-bridge circuit is usually realized by switching elements configured by power semiconductors. Flow and transformation of current are realized through the turn on and turn off control of the switching elements.

At present, main power semiconductor transistors commonly used in the field of motor driving include an IGBT, a MOSFET, a silicon carbide MOFSET, a silicon carbide JFET, a gallium nitride HEMT, etc. Among them, the most commonly used power semiconductor transistor is the IGBT, which has excellent performance and low price. Due to the existence of a tail current, the IGBT generally has a relatively slow switching speed and relatively large switching loss. In applications with a high switching frequency, the efficiency of a three-phase full-bridge motor drive circuit configured by IGBT is relatively low.

### SUMMARY

In view of the above, the present disclosure discloses a multi-phase full-bridge drive system for driving a motor using a low switching loss power semiconductor transistor and a high switching loss power semiconductor transistor, and a method for driving a motor. A multi-phase full-bridge drive circuit in the multi-phase full-bridge drive system includes at least three half-bridge circuits, which utilize a combination of hybrid devices consisting of a low switching loss power semiconductor transistor and a high switching loss power semiconductor transistor. Furthermore, effective switching times of the high switching loss power semiconductor transistor are reduced by a discontinuous pulse width modulation (DPWM) control method, thereby reducing switching loss of the high switching loss power semiconductor transistor. DPWM means that in any one or more vector control cycles, switching elements/transistors of an upper bridge arm and a lower bridge arm of one half-bridge circuit of the three-phase full-bridge circuit do not perform switching actions, but remain in ON state or OFF state. In this way, advantages of two types of power semiconductor transistors with different characteristics may be fully utilized. In particular, in a multi-phase full-bridge drive system including a half-bridge circuit formed by combining an IGBT with another type of transistor, advantages of the IGBT may be exerted while reducing switching loss of the IGBT, thereby expanding its application range and extending its service life.

In one aspect, the present disclosure discloses a multi-phase full-bridge drive system for driving a motor, including: a multi-phase full-bridge circuit including at least three identical half-bridge circuits, wherein each of the half-bridge circuits includes a first transistor and a second transistor, and switching loss of the first transistor is less than switching loss of the second transistor; and a controller used to control the multi-phase full-bridge circuit to generate target multi-phase drive voltages for driving the motor, wherein the controller is configured to select a half-bridge circuit from the at least three half-bridge circuits based on a power factor of the motor and the target multi-phase drive voltages, and reduce effective switching times of the second transistor of the selected half-bridge circuit. Effective switching times of a power semiconductor transistor mentioned in the present disclosure refers to the number of times the power semiconductor transistor is turned on or off accompanied by the generation of switching losses, and invalid switching times of a power semiconductor transistor mentioned in the present disclosure refers to the number of times the power semiconductor transistor is turned on or off that is not accompanied by the generation of switching losses, as further explained below with respect to the accompanying drawings.

In one embodiment, a terminal of the first transistor of each of the half-bridge circuits for connecting to a power supply is connected to a positive potential of a DC power supply, a terminal of the second transistor of each of the half-bridge circuits for connecting to the power supply is connected to a negative potential of the DC power supply, and selecting a half-bridge circuit from the at least three half-bridge circuits based on the power factor of the motor and the target multi-phase drive voltages includes: in response to the power factor of the motor being greater than zero, selecting a half-bridge circuit associated with one phase with the smallest instantaneous voltage value in the target multi-phase drive voltages from the at least three half-bridge circuits; and in response to the power factor of the motor being smaller than zero, selecting a half-bridge circuit associated with one phase with the greatest instantaneous voltage value in the target multi-phase drive voltages from the at least three half-bridge circuits.

In one embodiment, reducing the effective switching times of the second transistor of the selected half-bridge circuit includes: the controller clamps the first transistor or the second transistor of the selected half-bridge circuit according to the power factor of the motor, so that the first transistor or the second transistor remains in an ON state. In one embodiment, reducing the effective switching times of the second transistor of the selected half-bridge circuit includes: in response to the power factor of the motor being greater than zero, clamping the second transistor of the selected half-bridge circuit so that the second transistor remains in an ON state; or in response to the power factor of the motor being smaller than zero, clamping the first transistor of the selected half-bridge circuit so that the first transistor remains in an ON state. In this case, both the effective switching times and the invalid switching times of the second transistor with greater switching loss could be reduced.

In one embodiment, reducing the effective switching times of the second transistor of the selected half-bridge circuit includes: the controller further determines a direction in which a current flows, and clamps the first transistor or the second transistor of the selected half-bridge circuit or controls the first transistor or the second transistor of the selected half-bridge circuit by continuous pulse width modulation (CPWM), according to both the power factor of the motor and the direction in which the current flows. This control strategy may reduce the switching times of the transistor with greater switching losses on the one hand, and optimize harmonic performance of the multi-phase full-bridge drive system on the other hand. In one embodiment, reducing the effective switching times of the second transistor of the selected half-bridge circuit includes: in response to the power factor of the motor being greater than zero, clamping the second transistor of the selected half-bridge circuit so that the second transistor remains in an ON state in response to the current flowing from the motor to the DC power supply, while controlling the first transistor and the second transistor of the selected half-bridge circuit to perform switching according to a CPWM control method in response to the current flowing from the DC power supply to the motor; or in response to the power factor of the motor being smaller than zero, clamping the first transistor of the selected half-bridge circuit so that the first transistor remains in an ON state in response to the current flowing from the motor to the DC power supply, while controlling the first transistor and the second transistor of the selected half-bridge circuit to perform switching according to the CPWM control method in response to the current flowing from the DC power supply to the motor. When the current flows from the DC power supply to the motor, the current may flow from the positive potential of the DC power supply to the motor via the first transistor, or may flow from the negative potential of the DC power supply to the motor via the diode of the lower bridge arm, and no current flows through the second transistor with greater switching power losses located in the lower bridge arm, so even if the second transistor is turned on or off, no actual switching loss is generated. Therefore, when the current flows from the DC power supply to the motor, there is no need to perform any clamping control on the first transistor or the second transistor. In one embodiment, when the current flows from the DC power supply to the motor, within the corresponding multiple vector control cycles, the first transistor and the second transistor may be turned on or off in a timely manner as in the conventional CPWM control method, so as to further optimize the harmonic performance of the multi-phase full-bridge drive system. In this case, the effective switching times of the second transistor are reduced without reducing the invalid switching times of the second transistor.

In one embodiment, short-circuit withstand capability of the first transistor is weaker than short-circuit withstand capability of the second transistor.

In one embodiment, the first transistor is selected from a group including a silicon carbide JFET, a gallium nitride HEMT, an IGBT and a silicon carbide MOSFET, and the second transistor is selected from a group including an IGBT, a silicon carbide MOSFET and a silicon carbide JFET.

In one embodiment, the first transistor and the second transistor are of a same transistor type, or the first transistor and the second transistor are of different device types, wherein the controller is further configured to, in response to the first transistor and the second transistor are of a same transistor type, configure the first transistor and the second transistor of each of the half-bridge circuits, respectively, by adjusting transistor driving parts connected to control terminals of the first transistor and the second transistor of the half-bridge circuit, so that the switching loss of the first transistor is less than the switching loss of the second transistor and/or short-circuit withstand capability of the first transistor is weaker than short-circuit withstand capability of the second transistor.

In one embodiment, the first transistor is a MOSFET or a silicon carbide JFET, and the second transistor is an IGBT.

In one embodiment, the first transistor is a normally-on transistor and the second transistor is a normally-off transistor, or the first transistor is a normally-off transistor and the second transistor is a normally-on transistor.

In one embodiment, in response to the three-phase full-bridge drive system being out of control, the normally-on transistors of all the half-bridge circuits are turned on simultaneously to put the motor into an active short-circuit state.

In one embodiment, the first transistor is a silicon carbide JFET or a gallium nitride HEMT, and the second transistor is an IGBT.

In one embodiment, each of the half-bridge circuits further includes a first diode connected to the first transistor in anti-parallel, and/or a second diode connected to the second transistor in anti-parallel.

In one embodiment, the first diode and the second diode are selected from a group including a silicon carbide diode with a Schottky structure and a fast recovery diode. Generally, a diode commutated with an IGBT may be configured as a fast recovery diode or a silicon carbide diode with a Schottky structure. A diode commutated with a silicon carbide JFET, a silicon carbide MOSFET, and a gallium nitride HEMT is configured as a silicon carbide diode with a Schottky structure. Optionally, the first diode and/or the second diode may be omitted.

In another aspect, the present disclosure also discloses a method for driving a motor, including: configuring a multi-phase full-bridge circuit so that the multi-phase full-bridge circuit includes at least three identical half-bridge circuits, wherein each of the half-bridge circuits includes a first transistor and a second transistor, and switching loss of the first transistor is less than switching loss of the second transistor; and controlling, via a controller, the multi-phase full-bridge circuit to generate target multi-phase drive voltages for driving the motor, including selecting, via the controller, a half-bridge circuit from the at least three half-bridge circuits based on a power factor of the motor and the target multi-phase drive voltages, and reducing effective switching times of the second transistor of the selected half-bridge circuit.

In one embodiment, a terminal of the first transistor of each of the half-bridge circuits for connecting to a power supply is connected to a positive potential of a DC power supply, a terminal of the second transistor of each of the half-bridge circuits for connecting to the power supply is connected to a negative potential of the DC power supply, and selecting a half-bridge circuit from the at least three half-bridge circuits based on the power factor of the motor and the target multi-phase drive voltages includes: in response to the power factor of the motor being greater than zero, selecting a half-bridge circuit associated with one phase with the smallest instantaneous voltage value in the target multi-phase drive voltages from the at least three half-bridge circuits; and in response to the power factor of the motor being smaller than zero, selecting a half-bridge circuit associated with one phase with the greatest instantaneous voltage value in the target multi-phase drive voltages from the at least three half-bridge circuits.

In one embodiment, reducing the effective switching times of the second transistor of the selected half-bridge circuit includes: the controller clamps the first transistor or the second transistor of the selected half-bridge circuit according to the power factor of the motor, so that the first transistor or the second transistor remains in an ON state. In one embodiment, reducing the effective switching times of the second transistor of the selected half-bridge circuit includes: in response to the power factor of the motor being greater than zero, clamping the second transistor of the selected half-bridge circuit so that the second transistor remains in an ON state; or in response to the power factor of the motor being smaller than zero, clamping the first transistor of the selected half-bridge circuit so that the first transistor remains in an ON state. In this case, both the effective switching times and the invalid switching times of the second transistor with greater switching loss could be reduced.

In one embodiment, reducing the effective switching times of the second transistor of the selected half-bridge circuit includes: the controller further determines a direction in which a current flows, and clamps the first transistor or the second transistor of the selected half-bridge circuit or controls the first transistor or the second transistor of the selected half-bridge circuit through the CPWM, according to the power factor of the motor and the direction in which the current flows. This control strategy may reduce the switching times of the transistor with greater switching power losses on the one hand, and optimize harmonic performance of the multi-phase full-bridge drive system on the other hand. In one embodiment, reducing the effective switching times of the second transistor of the selected half-bridge circuit includes: in response to the power factor of the motor being greater than zero, clamping the second transistor of the selected half-bridge circuit so that the second transistor remains in an ON state in response to the current flowing from the motor to the DC power supply, while controlling the first transistor and the second transistor of the selected half-bridge circuit to perform switching according to the CPWM control method in response to the current flowing from the DC power supply to the motor; or in response to the power factor of the motor being smaller than zero, clamping the first transistor of the selected half-bridge circuit so that the first transistor remains in an ON state in response to the current flowing from the motor to the DC power supply, while controlling the first transistor and the second transistor of the selected half-bridge circuit to perform switching according to the CPWM control method in response to the current flowing from the DC power supply to the motor. When the current flows from the DC power supply to the motor, the current may flow from the positive potential of the DC power supply to the motor via the first transistor, or may flow from the negative potential of the DC power supply to the motor via the diode of the lower bridge arm, and no current flows through the second transistor with greater switching power losses located in the lower bridge arm, so even if the second transistor is turned on or off, no actual switching loss is generated. Therefore, when the current flows from the DC power supply to the motor, there is no need to perform any clamping control on the first transistor or the second transistor. In one embodiment, when the current flows from the DC power supply to the motor, within the corresponding multiple vector control cycles, the first transistor and the second transistor may be turned on or off in a timely manner as in the conventional CPWM control method, so as to further optimize the harmonic performance of the multi-phase full-bridge drive system. In this case, the effective switching times of the second transistor may be reduced without reducing the invalid switching times of the second transistor.

In one embodiment, short-circuit withstand capability of the first transistor is weaker than short-circuit withstand capability of the second transistor.

In one embodiment, the first transistor is selected from a group including a silicon carbide JFET, a gallium nitride HEMT, an IGBT and a silicon carbide MOSFET, and the second transistor is selected from a group including an IGBT, a silicon carbide MOSFET and a silicon carbide JFET.

In one embodiment, the first transistor and the second transistor are of a same transistor type, or the first transistor and the second transistor are of different device types, wherein the method further includes: in response to the first transistor and the second transistor are of a same transistor type, configuring, via the controller, the first transistor and the second transistor of each of the half-bridge circuits, respectively, by adjusting transistor driving parts connected to control terminals of the first transistor and the second transistor of each of the half-bridge circuit, so that the switching loss of the first transistor is less than the switching loss of the second transistor and/or short-circuit withstand capability of the first transistor is weaker than short-circuit withstand capability of the second transistor

In one embodiment, the first transistor is a MOSFET or a silicon carbide JFET, and the second transistor is an IGBT.

In one embodiment, the first transistor is a normally-on transistor and the second transistor is a normally-off transistor, or the first transistor is a normally-off transistor and the second transistor is a normally-on transistor.

In one embodiment, the method further includes: in response to the three-phase full-bridge drive system being out of control, the normally-on transistors of all the half-bridge circuits are turned on simultaneously to put the motor into an active short-circuit state.

In one embodiment, the first transistor is a silicon carbide JFET or a gallium nitride HEMT, and the second transistor is an IGBT.

In one embodiment, each of the half-bridge circuits further includes a first diode connected to the first transistor in anti-parallel, and/or a second diode connected to the second transistor in anti-parallel.

In one embodiment, the first diode and the second diode are selected from a group including a silicon carbide diode with a Schottky structure and a fast recovery diode.

The first transistor and the second transistor in the embodiments of the multi-phase full-bridge drive system and the embodiments of the method for driving a motor as mentioned above may be replaced with each other. Therefore, in another embodiment, the terminal of the second transistor of each of the half-bridge circuits for connecting to the power supply is connected to the positive potential of the DC power supply, and the terminal of the first transistor of each of the half-bridge circuits for connecting to the power supply is connected to the negative potential of the DC power supply. Accordingly, a control strategy opposite to the control strategy in the above-mentioned embodiments is used to achieve the target multi-phase drive voltages for driving the motor. Specifically, the controller is configured to/the controller is utilized to: in response to the power factor of the motor being greater than zero, selecting a half-bridge circuit associated with one phase with the greatest instantaneous voltage value in the target multi-phase drive voltages from the at least three half-bridge circuits; and in response to the power factor of the motor being smaller than zero, selecting a half-bridge circuit associated with one phase with the smallest instantaneous voltage value in the target multi-phase drive voltages from the at least three half-bridge circuits. With regard to the clamping control of the first transistor and the second transistor, in one embodiment, in response to the power factor of the motor being greater than zero, the second transistor of the selected half-bridge circuit is controlled so that the second transistor remains in an ON state; and in response to the power factor of the motor being smaller than zero, the first transistor of the selected half-bridge circuit is controlled so that the first transistor remains in an ON state. In another embodiment, in response to the power factor of the motor being greater than zero, a direction of a current is further determined, and only in response to the current flowing from the DC power supply to the motor, the second transistor of the selected half-bridge circuit is controlled so that the second transistor remains in an ON state; and in response to the power factor of the motor being smaller than zero, the direction of the current is further determined, and only in response to the current flowing from the DC power supply to the motor, the first transistor of the selected half-bridge circuit is controlled so that the first transistor remains in an ON state. In the case of an opposite current direction, that is, when the current flows from the motor to the DC power supply, the current will not flow from the motor to the DC power supply through the second transistor, that is, no switching loss will be generated by turning on or off the second transistor with greater switching loss, so no matter what the power factor is, there is no need to perform any clamping control on the first transistor or the second transistor. In one embodiment, when the current flows from the motor to the DC power supply, within the corresponding multiple vector control cycles, the first transistor and the second transistor may be turned on or off in a timely manner as in the conventional CPWM control method, so as to further optimize the harmonic performance of the multi-phase full-bridge drive system.

### BRIEF DESCRIPTION OF THE DRAWINGS

Specific exemplary embodiments of the present disclosure will now be described with reference to the accompanying drawings. Features, aspects and advantages of the present disclosure will become apparent from reviewing the following detailed description together with the accompanying drawings. In the accompanying drawings:

FIG. 1 shows a schematic diagram of a conventional CPWM control method for driving a motor;

FIG. 2 shows a schematic diagram of a three-phase full-bridge drive system for driving a motor according to an embodiment of the present disclosure;

FIGS. 3a and 3b show schematic diagrams of a control method for driving a motor when a power factor is greater than 0 and a power factor is smaller than 0 according to an embodiment of the present disclosure, respectively.

FIG. 4 shows a schematic diagram of a three-phase full-bridge drive system for driving a motor according to an embodiment of the present disclosure;

FIG. 5 shows a schematic diagram of a three-phase full-bridge drive system for driving a motor according to an embodiment of the present disclosure;

FIG. 6 shows a schematic diagram of a three-phase full-bridge drive system for driving a motor according to an embodiment of the present disclosure;

FIG. 7 shows a schematic diagram of a three-phase full-bridge drive system for driving a motor according to an embodiment of the present disclosure;

FIG. 8 shows a schematic diagram of a three-phase full-bridge drive system for driving a motor according to an embodiment of the present disclosure; and

FIG. 9 shows a schematic diagram of a three-phase full-bridge drive system for driving a motor according to an embodiment of the present disclosure.

### DETAILED DESCRIPTION

Some implementations of the present disclosure will now be described more fully hereinafter with reference to the accompanying drawings, in which some but not all implementations of the present disclosure are shown. In fact, various implementations of the disclosure may be embodied in many different forms and should not be construed as limited to the implementations set forth herein. Instead, these exemplary implementations are provided to convey the scope of the disclosure to those skilled in the art better.

FIG. 1 shows a schematic diagram of a conventional CPWM control method for driving a motor. Specifically, FIG. 1 shows switching actions of a bridge arm of each phase for the CPWM control method. 221, 222, and 223 represent switching actions of x, y, and z phases, respectively. Conventionally, two switching elements or transistors of upper and lower bridge arms of each of three half-bridges of a three-phase full-bridge circuit are respectively controlled by a continuous pulse width modulation (CPWM) method to achieve the driving of the motor. CPWM means that the switching elements of the upper and lower bridge arms of each of the half-bridges take action once in each vector control cycle. The present disclosure adopts a DPWM control method to reduce effective switching times of a transistor with larger switching loss, thereby reducing switching loss of the entire multi-phase full-bridge drive system. In one embodiment, CPWM control may also be combined to further optimize harmonic performance of the multi-phase full-bridge drive system while reducing the switching loss of the entire multi-phase full-bridge drive system.

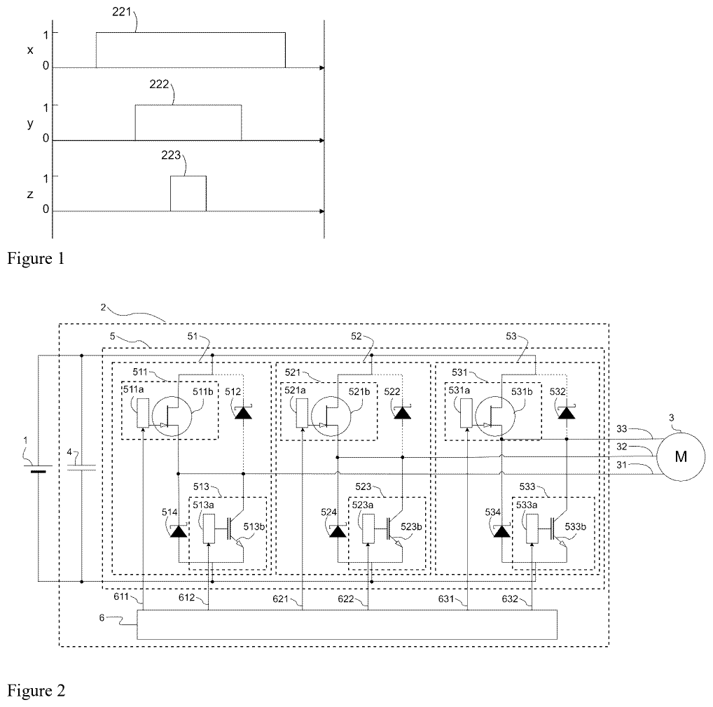

FIG. 2 shows a schematic diagram of a three-phase full-bridge drive system 2 for driving a motor according to an embodiment of the present disclosure. In FIG. 2, a DC power supply 1 supplies DC power to the three-phase full-bridge drive system 2. In one embodiment, the DC power supply 1 is a rechargeable battery. The three-phase full-bridge drive system 2 outputs a target three-phase drive voltage for driving a synchronous motor or an asynchronous motor 3. The three-phase full-bridge drive system 2 includes a three-phase full-bridge circuit 5 and a controller 6. In another embodiment, the three-phase full-bridge drive system 2 also includes a smoothing capacitor 4.

The three-phase full-bridge circuit 5 is a DC-AC conversion circuit that may convert a DC voltage applied by the DC power supply 1 into a three-phase AC power for driving the motor 3, and may also convert a three-phase AC power generated by the motor into DC power. The three-phase full-bridge circuit is configured by three half-bridge circuits 51, 52, and 53. The half-bridge circuits are connected to three terminals 31, 32, and 33 of the motor 3, respectively.

The controller 6 is used to transmit a control signal to transistor driving parts 511a, 521a, 531a, 513a, 523a, and 533a in the motor driving circuit through signal terminals 611, 612, 621, 622, 631, and 632 for controlling the three-phase full-bridge circuit 5. The controller 6 may be implemented in the form of a programmable logic device, a processor, a microprocessor, etc. The transistor driving parts 511a, 521a, 531a, 513a, 523a, and 533a are connected to control terminals of transistors of the upper bridge arms and the lower bridge arms of each of the half-bridge circuits, respectively, to drive the corresponding transistors to be turned on or off. In one embodiment, each transistor driving part may also configure performance of the transistor connected thereto, for example configure its switching loss, short-circuit withstand capability and the like.

Three half-bridge circuits 51, 52, 53 are identical. For the sake of clarity, only the half-bridge circuit 51 is described in detail here. The half-bridge circuit 51 is configured by an upper bridge arm and a lower bridge arm, and the upper bridge arm is connected to a positive potential of the DC power supply 1 and the motor terminal 31. The lower bridge arm is connected to a negative potential of the DC power supply 1 and the motor terminal 31. The upper bridge arm shown in FIG. 2 includes a switching element 511 and a power semiconductor diode 512 connected to the switching element 511 in anti-parallel. The switching element 511 includes a power semiconductor transistor 511b and a transistor driving part 511a connected to a control terminal of the power semiconductor transistor 511b for driving or otherwise configuring the power semiconductor transistor 511b. The transistor driving part 511a receives a control signal 611 from a controller 6, thereby realizing the control of the upper bridge arm by the controller 6. The lower bridge arm includes a switching element 513 and a power semiconductor diode 514 connected to the switching element 513 in anti-parallel. The switching element 513 includes a power semiconductor transistor 513b and a transistor driving part 513a connected to a control terminal of the power semiconductor transistor 513b for driving or otherwise configuring the power semiconductor transistor 513b. The transistor driving part 513a receives a control signal 612 from the controller 6, thereby realizing the control of the lower bridge arm by the controller 6. Switching loss of the power semiconductor transistor 511b of the upper bridge arm is less than switching loss of the power semiconductor transistor 513b of the lower bridge arm. It should be noted that, the switching element shown in FIG. 2 is illustrated as including a transistor and a corresponding transistor driving part, which may be integrated with each other, or alternatively, may be realized as separate devices. In another embodiment, the transistor driving part may be integrated in the controller 6.

The power semiconductor transistor 511b is configured by a silicon carbide JFET, and the power semiconductor diode 514 forming a commutation loop with the power semiconductor transistor 511b is configured by a silicon carbide diode or a fast recovery diode. The power semiconductor transistor 513b is configured by an IGBT, and the power semiconductor diode 512 forming a commutation loop with the power semiconductor transistor 513b includes a silicon carbide diode or a fast recovery diode. The silicon carbide diode includes a silicon carbide Schottky barrier diode (SBD), a silicon carbide junction barrier Schottky (JBS) and a silicon carbide Merged pin Schottky (MPS). The fast recovery diode is generally silicon-based, which has good forward conduction performance, and a lower cost than that of the silicon carbide diode with a Schottky structure. Therefore, if a diode is optionally provided in anti-parallel, providing the diode in the three-phase full-bridge drive system 2 as a fast recovery diode may facilitate the utilization of the good forward conduction performance of the fast recovery diode. Since the power semiconductor transistor 511b has a certain reverse conduction capability, the power semiconductor diode 512 may not be provided. If the power semiconductor diode 512 is not provided, reverse recovery will occur on the power semiconductor transistor 511b, and thus, a reverse recovery loss on the power semiconductor transistor 511b will be larger when the power semiconductor transistor 513b is turned on, while the cost of the whole three-phase full-bridge drive system may be reduced because a group of diodes are omitted. In addition, when the transistor of the lower bridge arm is an IGBT, the diode connected in anti-parallel thereto may also be integrated into the IGBT module, and is externally presented as a whole. When such an IGBT with an integrated diode is used, no additional diode connected in anti-parallel may be configured externally.

The transistor driving part 511a may control the power semiconductor transistor 511b to enter an ON state, and connect the corresponding motor terminal 31 to the positive potential of the DC power supply. The transistor driving part 513a may control the power semiconductor transistor 513b to enter an ON state, and connect the corresponding motor terminal 31 to the negative potential of the DC power supply. When the transistor driving part 511a of the upper bridge arm controls the power semiconductor transistor 511b to be in the ON state, the transistor driving part 513a of the corresponding lower bridge arm controls the power semiconductor transistor 513b to be in the OFF state; when the transistor driving part 513a of the lower bridge arm controls the power semiconductor transistor 513b to be in the ON state, the transistor driving part 511a of the corresponding upper bridge arm controls the power semiconductor transistor 511b to be in the OFF state. When the switching elements of the upper and lower bridge arms switch on and off, a certain dead period is generally set, during which the switching elements of the upper and lower bridge arms are in the OFF state at the same time, so as to ensure that a current does not flow from the upper bridge arm to the lower bridge arm directly.

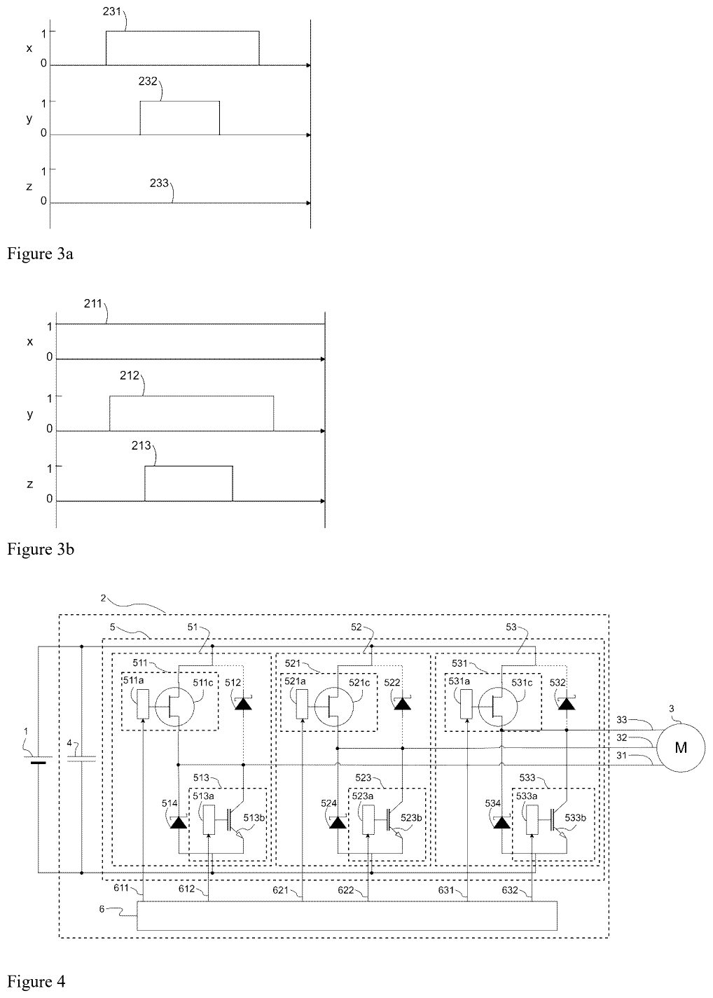

FIGS. 3a and 3b show schematic diagrams of a control method for driving a motor when a power factor is greater than 0 and a power factor is smaller than 0 according to an embodiment of the present disclosure, respectively. The x, y and z coordinate axes in FIGS. 3a and 3b represent switching actions of upper and lower bridge arms of three bridge arms, respectively. When an ordinate corresponding to a phase is 1, it indicates that the upper bridge arm of the half-bridge circuit associated with the phase is turned on and the lower bridge arm of the half-bridge circuit associated with the phase is turned off. When the ordinate is 0, it indicates that the lower bridge arm of the half-bridge circuit associated with the phase is turned on and the upper bridge arm of the half-bridge circuit associated with the phase is turned off. The x, y and z phases shown in FIGS. 3a and 3b each may be generated by any one of the half-bridge circuits 51, 52 or 53 in FIG. 2. For example, the three-phase full-bridge drive system 2 may be configured so that the half-bridge circuits 51, 52 or 53 are used to generate voltages of the x, y and z phases, respectively. In this case, it may be said that the half-bridge circuits 51, 52 or 53 are associated with the x, y and z phases, respectively. In other embodiments, other configuration combinations may also exist.

FIG. 3a shows switching action waveforms of bridge arms corresponding to three phases when a power factor of a three-phase full-bridge drive system is greater than 0. Wherein, 231 is a switching action waveform of the x phase, 232 is the switching action waveform of the y phase, and 233 is the switching action waveform of the z phase. That is, in a single vector control cycle, a lower bridge arm of a half-bridge circuit associated with a phase (z phase as shown in FIG. 3a) with the smallest instantaneous vector phase voltage among the three phases is kept in an ON state, that is, the transistor in the lower bridge arm of the phase is clamped to the negative potential of the DC power supply 1. In this case, since the power semiconductor transistor of the lower bridge arm of the half-bridge circuit associated with the z phase does not perform a switching action but remains in an ON state, as shown in the control waveform of the z phase in FIG. 3a, switching loss of the power semiconductor transistor of the lower bridge arm is reduced. In this case, in one embodiment, this control strategy may be adopted in each of multiple corresponding vector control cycles, thereby reducing switching loss of the entire three-phase full-bridge drive system. In another embodiment, this control strategy may be adopted in some of the multiple corresponding vector control cycles.

In this case, if a current of the z-phase flows from the DC power supply to the motor, specifically, the current flows from the positive potential of the DC power supply 1 to the motor via the upper bridge arm (e.g., the transistor 531b) of the half-bridge circuit associated with the z phase, or the current flows from the negative potential of the DC power supply 1 to the motor via the diode (e.g., the diode 534) of the lower bridge arm associated with the z phase, since no current flows through the power semiconductor transistor (e.g., the transistor 533b) of the lower bridge arm of the half-bridge circuit associated with the z phase, the transistor of the lower bridge arm is in an invalid ON state. In this case, the power semiconductor transistor of the lower bridge arm of the half-bridge circuit associated with the z phase may not be kept in the ON state, but may be turned off or turned on according to the CPWM control method. Moreover, since no current flows through the power semiconductor transistor of the lower bridge arm in this case, even if switching is performed by using the CPWM control method, no actual switching loss will be generated in the power semiconductor transistor of the lower bridge arm, and such switching is invalid switching. In one embodiment, when the power factor is greater than 0, the controller 6 may further determine a direction of a current, and the transistor of the lower bridge arm is clamped only when the current flows from the motor to the DC power supply, while the transistor of the lower bridge arm is not clamped when it is determined that the current flows from the DC power supply to the motor. For example, the transistor of the lower bridge arm may be timely controlled to perform switching actions according to the conventional CPWM control method, so as to further optimize the harmonic performance of the three-phase full-bridge drive system.

It should be pointed out that, FIG. 3a only shows the switching action waveforms for controlling three half-bridges. In fact, before obtaining the switching action waveforms, the controller 6 needs to select a specific half-bridge circuit based on the target three-phase drive voltage of the motor. In one embodiment, the target three-phase drive voltage is directly given by a user or another input. In the embodiment of the drive system configuration shown in FIG. 2, the controller 6 selects a half-bridge circuit associated with a phase with the smallest instantaneous voltage value in the target three-phase drive voltage of the motor from the three half-bridge circuits in response to the power factor of the motor being greater than zero, and clamps the second transistor of the selected half-bridge circuit, that is, the transistor with greater switching loss, to the negative potential of the DC power supply 1. In the embodiment of FIG. 3a, the controller 6 finds that an instantaneous vector voltage value of the z phase is the smallest by comparison, so a half-bridge circuit associated with the z phase (that is, the half-bridge circuit used to generate a z phase target voltage, such as the half-bridge circuit 53) is selected. In another embodiment, the half-bridge circuit associated with the z phase may be another half-bridge circuit. Then the second transistor of the selected half-bridge circuit (for example, the transistor 533b of the lower bridge arm of the half-bridge circuit 53) is clamped to the negative potential of the DC power supply 1. In one embodiment, the control terminal of the second transistor (for example, the transistor 533b of the lower bridge arm of the half-bridge circuit 53) is driven to a corresponding voltage by using a corresponding transistor driving part so that the second transistor is turned on, so as to clamp the second transistor to the negative potential of the DC power supply 1.

FIG. 3b shows switching action waveforms of bridge arms corresponding to three phases when a power factor of a three-phase full-bridge drive system is smaller than 0. Wherein, 211 is a control waveform of the x phase, 212 is a control waveform of the y phase, and 213 is a control waveform of the z phase. That is, in a single vector control cycle, an upper bridge arm of a half-bridge circuit associated with a phase (x phase as shown in FIG. 3b) with the greatest instantaneous vector phase voltage among the three phases is kept in an ON state, that is, the transistor in the upper bridge arm of the phase is clamped to the positive potential of the DC power supply 1. In this case, since the power semiconductor transistor of the lower bridge arm of the half-bridge circuit associated with the x phase does not perform a switching action but remains in an OFF state, as shown in the control waveform of the x phase in FIG. 3b, switching loss of the power semiconductor transistor of the lower bridge arm is reduced. In one embodiment, this control strategy may be adopted in each of multiple vector control cycles, thereby reducing switching loss of the entire three-phase full-bridge drive system. In another embodiment, this control strategy may be adopted in some of the multiple corresponding vector control cycles.

In this case, if a current of the x-phase flows from the DC power supply to the motor, specifically, the current flows from the positive potential of the DC power supply 1 to the motor via the upper bridge arm (e.g., the transistor 511b) of the half-bridge circuit associated with the x phase, or the current flows from the negative potential of the DC power supply 1 to the motor via the diode (e.g., the diode 514) of the lower bridge arm associated with the x phase, even if the upper bridge arm of the x phase is not kept in an ON state, that is, the transistor of the upper bridge arm is not clamped to the positive potential of the DC power supply, no current flows through the power transistor (e.g., the transistor 513b) of the lower bridge arm of the half-bridge circuit associated with the x phase, and no switching loss would be generated in the transistor of the lower bridge arm. In this case, in corresponding multiple vector control cycles, CPWM may be used to control the transistor of the upper bridge arm (for example, the transistor 511b) to perform switching actions in a timely manner without clamping the transistor of the upper bridge arm. Therefore, in one embodiment, when the power factor is smaller than 0, the controller 6 may further determine a direction of a current, and the transistor of the upper bridge arm is clamped only when the current flows from the motor to the DC power supply, while the transistor of the upper bridge arm is not clamped when it is determined that the current flows from the DC power supply to the motor. For example, the transistor of the lower bridge arm may be timely controlled according to the conventional CPWM control method to perform switching actions, so as to further optimize the harmonic performance of the three-phase full-bridge drive system.

It should be pointed out that, FIG. 3b only shows the switching action waveforms for controlling three half-bridges. In fact, before obtaining the switching action waveforms as shown, the controller 6 needs to select a specific half-bridge circuit based on the target three-phase drive voltage of the motor. In one embodiment, the target three-phase drive voltage is directly given by a user or another input. In the embodiment of the drive system configuration shown in FIG. 2, the controller 6 selects a half-bridge circuit associated with a phase with the greatest instantaneous voltage value in the target three-phase drive voltage of the motor from the three half-bridge circuits in response to the power factor of the motor being smaller than zero, and clamps the first transistor of the selected half-bridge circuit, that is, the transistor with smaller switching loss, to the positive potential of the DC power supply 1. In the embodiment of FIG. 3b, the controller 6 finds that an instantaneous vector voltage value of the x phase is the greatest by comparison, so a half-bridge circuit associated with the x phase (that is, the half-bridge circuit used to generate a x phase voltage, such as the half-bridge circuit 51) is selected. In another embodiment, the half-bridge circuit associated with the x phase may be another half-bridge circuit. Then the first transistor of the selected half-bridge circuit (for example, the transistor 513b of the upper bridge arm of the half-bridge circuit 51) is clamped to the positive potential of the DC power supply 1. The control terminal of the first transistor (for example, the transistor 511b of the upper bridge arm of the half-bridge circuit 51) is driven to a corresponding voltage by using a corresponding transistor driving part so that the first transistor is turned on, so as to clamp the first transistor to the positive potential of the DC power supply 1.

As explained above with respect to FIG. 2 and FIGS. 3a and 3b, and as illustrated in FIGS. 3a and 3b, when a transistor of a lower bridge arm of a phase is clamped, a transistor of an upper bridge arm does not perform any switching actions neither, and vice versa. That is to say, in the embodiments explained with respect to FIG. 2 and FIGS. 3a and 3b, while switching times of a transistor of a lower bridge arm with greater switching loss are reduced, switching times of a transistor of an upper bridge arm are reduced as well. However, reduction of the switching times of the transistor of the lower bridge arm with greater switching loss includes the reduction of effective switching times, and optionally, the reduction of invalid switching times. Reduction of the switching times of the transistor of the upper bridge arm with less switching loss only includes reduction of invalid switching times. In addition, the reduction of the effective switching times of the transistor with greater switching loss refers to a partial reduction rather than a complete elimination of its effective switching times, for example, the reduced effective switching times account for about 10% to 50% (for example, 30%) of the total original effective switching times such as in the CPWM control method. The above three-phase full-bridge drive system could achieve the target three-phase drive voltage for the motor, and may reduce the effective switching times of the transistor with greater switching loss to a considerable extent without increasing the switching loss of the transistor with smaller switching loss, thereby reducing switching loss of the entire three-phase full-bridge drive system and improving efficiency of the system.

In this embodiment, the IGBT has a low cost, stable performance and high reliability. Switching performance of the silicon carbide JFET is good, that is, switching loss is low. In addition, the cost of the silicon carbide JFET is lower than that of the silicon carbide MOSFET, and the silicon carbide JFET has high reliability due to the absence of a gate oxide layer. During a switching process of the power semiconductor transistor IGBT of the lower bridge arm, if current flows from a collector of the power semiconductor transistor IGBT to an emitter of the power semiconductor transistor IGBT, switching loss would be generated by the power semiconductor transistor IGBT, and such a switching process is called an effective switching process. During a switching process of the power semiconductor transistor IGBT of the lower bridge arm, if current does not flow through the power semiconductor transistor IGBT, but flows through a diode in anti-parallel with the power semiconductor transistor IGBT, no switching loss would be generated by the power semiconductor transistor IGBT, and such a switching process is called an invalid switching process. Since the effective switching times of the IGBT are reduced as compared to the conventional CPWM control method in each vector control cycle of multiple vector control cycles, switching loss of the entire three-phase full-bridge drive system may be reduced and efficiency of the system may be improved. Meanwhile, due to the introduction of DPWM, in addition to optimizing the switching loss, a common-mode current of the system may be reduced as well, to alleviate a problem caused by corrosion due to a shaft current of the motor.

In this embodiment, the silicon carbide JFET is a normally-on device. When the three-phase full-bridge drive system shown in FIG. 2 is out of control voltage, the power semiconductor transistors 511b, 521b, and 531b configured by the silicon carbide JFETs are all in the ON state, thereby the motor enters an active short circuit (ASC) state. In the ASC state, in the bridge arms corresponding to three phases, the transistors located on all the upper bridge arms or all the lower bridge arms are all turned on at the same time. There are many advantages for motor driving, especially for motor driving in electric vehicles, by the implementation of ASC. Such advantages includes: when the whole vehicle is out of control, a reverse torque may be generated by the implementation of ASC, to achieve safe parking; when a power battery fails, the motor and motor controller are isolated from the power battery by the implementation of ASC, to ensure high-voltage safety of the whole vehicle; when a switch device in a inverter circuit of the motor controller fails, a damage of uncontrollable rectifier current to another device or the power battery may be avoided by the implementation of ASC. The existing control methods for making a drive system with both the upper and lower bridges being configured by IGBTs or other normally-off transistors enter the ASC state when a fault occurs are complicated and difficult to implement reliably. As for the three-phase full-bridge drive system shown in FIG. 2, the combination of normally-on transistors and normally-off transistors is adopted, so that the normally-on transistors in the three-phase full-bridge circuit may be automatically turned on at the same time in case of drive system failure or another failure, so that terminals for three phases of the motor are short-circuited through the upper bridge arm, and the motor enters the ASC state without an additional complicated control method. Therefore, the embodiment described with reference to FIG. 1 and FIGS. 3a and 3b has great practicability and benefits when applied to the field of electric vehicles.

FIG. 4 shows a schematic diagram of a three-phase full-bridge drive system for driving a motor according to an embodiment of the present disclosure. The embodiment shown in FIG. 4 may be referred to as a second embodiment. This embodiment is based on the first embodiment. In this embodiment, the power semiconductor transistors 511b, 521b, 531b configured by silicon carbide JFETs in the first embodiment are replaced by power semiconductor transistors 511c, 521c, 531c configured by depletion-type gallium nitride HEMTs. In this embodiment, a short-circuit saturation current of the depletion-type gallium nitride HEMT is higher than a short circuit saturation current of the IGBT.

In this embodiment, the IGBT has a low cost, stable performance and high reliability. The depletion-type gallium nitride HEMT has better switching performance, that is, low switching loss, and its cost is relatively low. Since effective switching times of the IGBT are reduced, the overall switching loss may be reduced, and efficiency of the system is improved. Meanwhile, due to the introduction of DPWM, in addition to optimizing the loss, a common-mode current of the system may be reduced as well, thereby alleviating a problem caused by corrosion due to a shaft current of the motor. Since the depletion-type gallium nitride HEMT is a normally-on device, when the system driving is out of a control voltage, the power semiconductor transistors 511c, 521c, and 531c configured by depletion-type gallium nitride HEMTs are all in an ON state, which may cause the motor 3 to enter the ASC state, as well. This is a great advantage for motor driving, especially for motor driving in electric vehicles. Therefore, this embodiment also brings the benefits related to ASC as described above with respect to FIG. 2.

In this embodiment, additionally, short-circuit withstand capability of the depletion-type gallium nitride HEMT is weak. However, in this embodiment, when a phase-to-phase short circuit or a bridge-arm short circuit occurs in the drive system, most of the bus voltage may be borne by the IGBT. In this case, the IGBT may be used to turn off the short-circuit current. In addition, since the IGBT itself has strong short-circuit withstand capability, the short-circuit current may be turned off reliably and stably. Alternatively or additionally, the depletion-type gallium nitride HEMT may also be used to turn off the short-circuit current. Since a voltage across the depletion-type gallium nitride HEMT is very low and actual short-circuit energy is also very small, the short-circuit current may be turned off reliably as well.

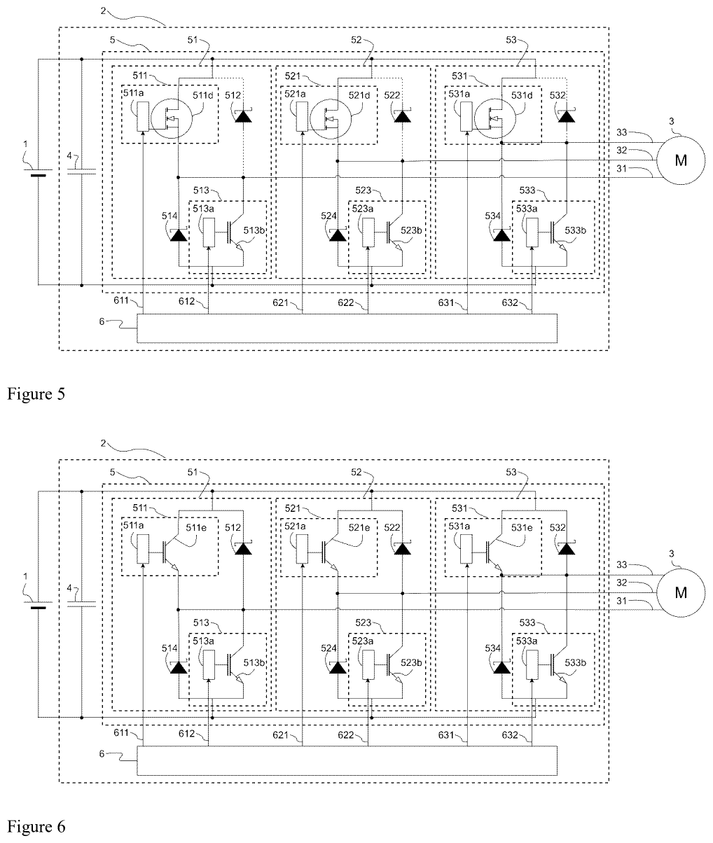

FIG. 5 shows a schematic diagram of a three-phase full-bridge drive system for driving a motor according to an embodiment of the present disclosure. The embodiment shown in FIG. 5 may be referred to as a third embodiment. This embodiment is based on the first embodiment. In this embodiment, the power semiconductor transistors 511b, 521b, and 531b configured by silicon carbide JFETs in the first embodiment are replaced by power semiconductor transistors 511d, 521d, and 531d configured by silicon carbide MOSFETs.

In this embodiment, the IGBT has a low cost, stable performance and high reliability. The silicon carbide MOSFET has better switching performance and low switching loss. Effective switching actions of the IGBT are reduced to a certain extent, which reduces the switching losses of the IGBT, without increasing the switching losses of the silicon carbide MOSFET additionally, and thus, the switching losses of the entire three-phase full-bridge drive system may be reduced, and efficiency of the system may be improved. Meanwhile, due to the introduction of DPWM, in addition to optimizing the loss, a common-mode current of the system may be reduced as well, thereby alleviating a problem caused by corrosion due to a shaft current of the motor. Meanwhile, since a switching speed of the IGBT is relatively slow, a problem that a crosstalk to the silicon carbide MOSFET is caused by an IGBT switching process would be alleviated, as well.

In this embodiment, additionally, the silicon carbide MOSFET may be configured to sacrifice short-circuit withstand capability to optimize conduction performance. In this embodiment, when a phase-to-phase short circuit or a bridge-arm short circuit occurs in the drive system, most of the bus voltage may be borne by the IGBT. In this case, the IGBT may be used to turn off the short-circuit current. In addition, since the IGBT itself has strong short-circuit withstand capability, the short-circuit current may be turned off reliably and stably. Alternatively or additionally, the silicon carbide MOSFET may also be used to turn off the short-circuit current. Since a voltage across the silicon carbide MOSFET is very low and actual short-circuit energy is also very small, the short-circuit current may be turned off reliably as well.

FIG. 6 shows a schematic diagram of a three-phase full-bridge drive system for driving a motor according to an embodiment of the present disclosure. The embodiment shown in FIG. 6 may be referred to as a fourth embodiment. This embodiment is based on the first embodiment. In this embodiment, the power semiconductor transistors 511b, 521b, 531b configured by silicon carbide JFETs in the first embodiment are replaced with power semiconductor transistors 511e, 521e, 531e configured by IGBTs. Switching loss of switching elements of an upper bridge arm including the power semiconductor transistors 511e, 521e, 531eand the transistor driving parts 511a, 521a, 531a thereof is less than switching loss of switching elements of a lower bridge arm including the power semiconductor transistors 513b, 523b, 533b and the transistor driving parts 513a, 523a, 533a thereof. The IGBTs constituting the power semiconductor transistors 513b, 523b, and 533b are designed to have a lower conduction voltage drop. In this case, the transistors of the upper bridge arm and the lower bridge arm are both IGBTs. Performances (such as switching loss and a conduction voltage drop) of the IGBTs or other transistors may be adjusted by adjusting a transistor driving part connected thereto, so that the IGBTs or the other transistors of the upper bridge arm exhibit different device performances from the IGBTs or other transistors of the lower bridge arm. Since the IGBT does not have reverse conduction capability, the power semiconductor diodes 512, 522, and 532 must be configured. In this embodiment, the power semiconductor transistors and power semiconductor diodes of the upper bridge arm may be integrated. That is, 511b and 512, 521b and 522, 531b and 532 are respectively integrated on a single chip, which is generally referred to as RC-IGBT (reverse conduct IGBT).

In this embodiment, the upper and lower bridge arms are both configured by IGBTs, and cost of the system is low. On one hand, effective switching times of the IGBT of the lower bridge arm with large switching losses are reduced, thereby reducing the switching losses. On the other hand, the IGBT with large switching losses has a low conduction voltage drop, which may reduce conduction losses. In this way, the losses of the system may be further reduced and efficiency of the system may be improved.

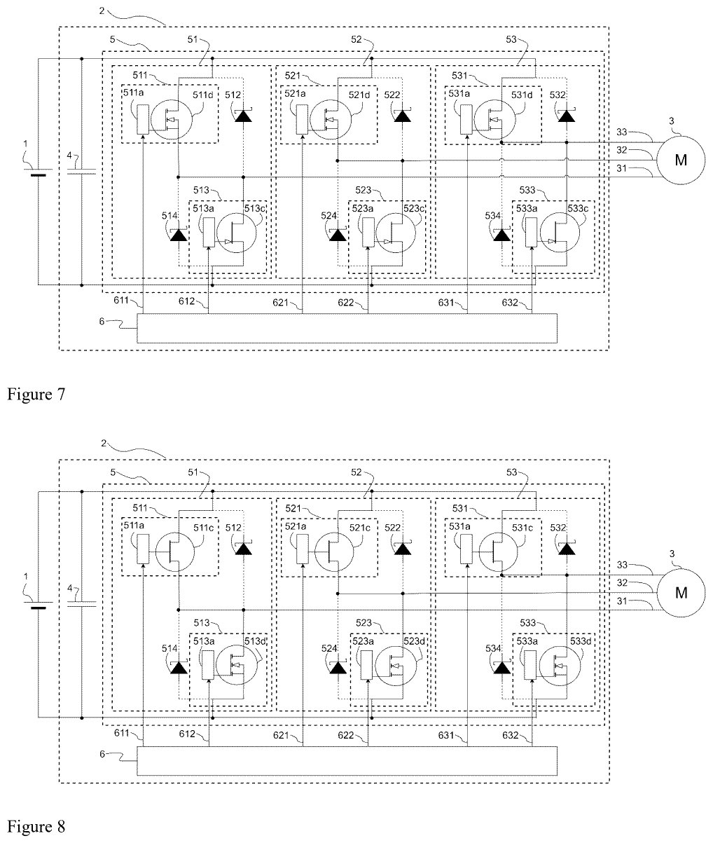

FIG. 7 shows a schematic diagram of a three-phase full-bridge drive system for driving a motor according to an embodiment of the present disclosure. The embodiment shown in FIG. 7 may be referred to as a fifth embodiment. This embodiment is based on the third embodiment. In this embodiment, the power semiconductor transistors 513b, 523b, and 533b configured by IGBTs in the third embodiment are replaced by power semiconductor transistors 513c, 523c, and 533c configured by silicon carbide JFETs.

In this embodiment, the silicon carbide JFETs have low cost without a problem caused by reliability of a gate oxide layer. The silicon carbide MOSFETs have better switching performance and low switching loss. Since effective switching times of the silicon carbide JFETs are reduced, the overall switching loss may be reduced. And efficiency of the system is improved. Meanwhile, due to the introduction of DPWM, in addition to optimizing the loss, a common-mode current of the system may be further reduced, thereby alleviating a problem caused by corrosion due to a shaft current of the motor.

In this embodiment, additionally, the silicon carbide MOSFET may be configured to sacrifice short-circuit withstand capability to optimize conduction performance, and the silicon carbide JFET is configured/designed to have stronger short-circuit withstand capability, and a lower short-circuit saturation current than the silicon carbide MOSFET. When a phase-to-phase short circuit or a bridge-arm short circuit occurs in the drive system, the silicon carbide JFET may be used to turn off the short-circuit current. Because the silicon carbide JFET has relatively strong short-circuit withstand capability, the short-circuit current may be turned off reliably and stably. Alternatively or additionally, the silicon carbide MOSFET may be used to turn off the short-circuit current. Since a voltage across the silicon carbide MOSFET is very low and actual short-circuit energy is also very small, the short-circuit current may be turned off reliably. Meanwhile, since the silicon carbide JFET is a normally-on device, when the system driving is out of a control voltage, the power semiconductor transistors 513c, 523c, and 533c configured by silicon carbide JFETs are all in an ON state, which may cause the motor to enter the ASC state. This is a great advantage for motor driving, especially for motor driving in electric vehicles. Therefore, this embodiment also brings the benefits related to ASC as described above with respect to other embodiments.

FIG. 8 shows a schematic diagram of a three-phase full-bridge drive system for driving a motor according to an embodiment of the present disclosure. The embodiment shown in FIG. 8 may be referred to as a sixth embodiment. This embodiment is based on a second embodiment. In this embodiment, the power semiconductor transistors 513b, 523b, 533b configured by IGBTs in the second embodiment are replaced with power semiconductor transistors 513d, 523d, 533d configured by silicon carbide MOSFETs. A saturation current of semiconductor transistors 511d, 521d, 531d is higher than that of power semiconductor transistors 513d, 523d, 533d. And the silicon carbide MOSFETs are configured or designed to have relatively strong short-circuit withstand capability and relatively low short-circuit saturation current.

In this embodiment, due to the introduction of DPWM, in addition to optimizing loss, a common-mode current of the system may be further reduced to alleviate a problem caused by corrosion due to a shaft current of the motor. Since the depletion-type gallium nitride HEMT is a normally-on device, when the system driving is out of a control voltage, the power semiconductor transistors 511c, 521c, and 531c formed by the depletion-type gallium nitride HEMTs are all in the ON state, so that the motor enters the ASC state. This is a great advantage for motor driving, especially for motor driving in electric vehicles. Therefore, this embodiment also brings the benefits related to ASC as described above with respect to other embodiments.

In this embodiment, the silicon carbide MOSFET is configured or designed to have strong short-circuit withstand capability, and a lower short-circuit saturation current than that of the gallium nitride HEMT. When a phase-to-phase short circuit or a bridge-arm short circuit occurs in the drive system, the silicon carbide MOSFET may be selected to turn off the short-circuit current. Since the silicon carbide MOSFET has relatively strong short-circuit withstand capability, the short-circuit current may be turned off reliably and stably. Alternatively or additionally, the gallium nitride HEMT may be selected to turn off the short-circuit current. Since a voltage across the gallium nitride HEMT is very low and actual short-circuit energy is also very small, the short-circuit current may be turned off reliably, as well.

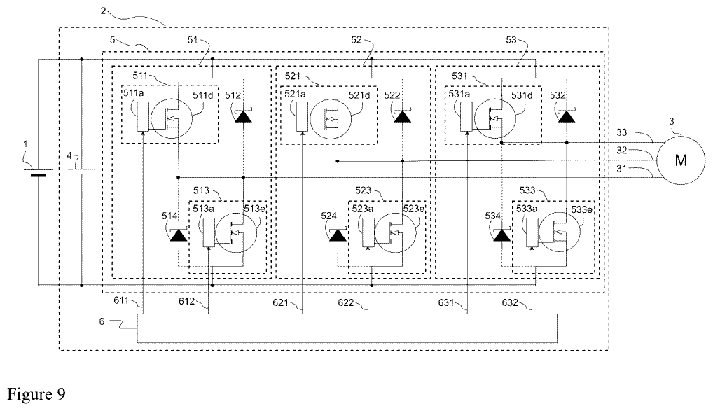

FIG. 9 shows a schematic diagram of a three-phase full-bridge drive system for driving a motor according to an embodiment of the present disclosure. The embodiment shown in FIG. 9 may be referred to as a seventh embodiment. This embodiment is based on the third embodiment. In this embodiment, the power semiconductor transistors 513b, 523b, 533b configured by IGBTs in the third embodiment are replaced by power semiconductor transistors 513e, 523e, 533e configured by silicon carbide MOSFETs. Therefore, both upper and lower bridges are configured by MOSFETs, and the silicon carbide MOSFET of the lower bridge arm is configured/designed to have a lower short-circuit saturation current than that of the silicon carbide MOSFET of the upper bridge arm.

In this embodiment, the power semiconductor transistors of both the upper and lower bridges are silicon carbide MOSFETs. In one embodiment, a same type of silicon carbide MOSFET is adopted for both the upper and lower bridges. A driving circuit (such as a transistor driving part) of the switching element of the lower bridge arm can be adjusted to appropriately reduce a gate drive voltage of the power semiconductor transistor to improve short-circuit withstand capability of the power semiconductor transistor of the lower bridge arm, so that switching loss and conduction withstand capability of the silicon carbide MOSFET of the lower bridge arm will increase. In another embodiment, the silicon carbide MOSFETs of the upper and lower bridge arms are of different models, and the silicon carbide MOSFET in the switching element of the lower bridge arm is designed to have strong short-circuit withstand capability.

In this embodiment, the short-circuit withstand capability of the switching element or transistor of the lower bridge arm is enhanced. In this embodiment, when a phase-to-phase short circuit or a bridge-arm short circuit occurs in the drive system, most of the bus voltage is borne by the silicon carbide MOSFET of the lower bridge arm. In this case, the silicon carbide MOSFET of the lower bridge arm may be selected to turn off the short-circuit current. Since the silicon carbide MOSFET of the lower bridge arm in this embodiment has strong short-circuit withstand capability, the short-circuit current may be turned off reliably and stably. Alternatively or additionally, the silicon carbide MOSFET of the upper bridge arm may also be selected to turn off the short-circuit current. Since a voltage across the silicon carbide MOSFET of the upper bridge arm is very low and actual short-circuit energy is also very small, the short-circuit current may be turned off reliably, as well.

The various embodiments described above in conjunction with the accompanying drawings relate to a first configuration, that is, each upper bridge arm includes a first transistor with smaller switching loss (that is, a terminal of the first transistor for connecting to a power supply is connected to a positive potential of a DC power supply), and each lower bridge arm includes a second transistor with larger switching loss (that is, a terminal of the second transistor for connecting to the power supply is connected to a negative potential of the DC power supply). When the power factor is greater than 0, in corresponding multiple vector control cycles, the lower bridge arm of a phase with the smallest instantaneous value of the equivalent phase voltage is kept on and clamped to the negative potential of the DC power supply to implement DPWM control, so as to reduce effective switching times of the second transistor of the lower bridge arm, thereby reducing switching loss of the lower bridge arm, and thus switching loss of the entire multi-phase full-bridge drive system is reduced. In this case, when a current of the phase flows from the bridge arm to the motor, since the current will not flow through the second transistor in the lower bridge arm of the phase, the lower bridge arm of the phase may not be kept on during this period, that is, the second transistor in the lower bridge arm is not clamped to the negative potential of the DC power supply. Instead, in the corresponding multiple vector control cycles, switching may be timely performed according to a CPWM method, thereby optimizing harmonic performance of the system. When the power factor is smaller than 0, in the corresponding multiple vector control cycles, the upper bridge arm of a phase with the largest instantaneous value of the equivalent phase voltage is kept on, that is, the first transistor of the upper bridge arm is clamped to the positive potential of the DC power supply, to achieve DPWM control. In this case, the second transistor of the lower bridge arm remains off, thereby reducing effective switching times of the lower bridge arm and reducing switching loss of the second transistor of the lower bridge arm. In this case, when a current of the phase flows from the bridge arm to the motor, the current will not flow through the second transistor in the lower bridge arm of the phase, and thus, in the corresponding multiple vector control cycles, the upper bridge arm of the phase may not be kept on, that is, the first transistor in the upper bridge arm is not clamped to the positive potential of the DC power supply. Instead, in the corresponding multiple vector control cycles, switching is timely performed according to a CPWM method, thereby optimizing harmonic performance of the system.

However, the first transistor of the upper bridge arm and the second transistor of the lower bridge arm in the various embodiments described above in conjunction with the accompanying drawings may be arranged in reverse. That is, in a second configuration, each upper bridge arm includes a second transistor with greater switching loss (i.e., a terminal of the second transistor for connecting a power supply is connected to a positive potential of a DC power supply), and each lower bridge arm includes a first transistor with less switching loss (i.e., a terminal of the first transistor for connecting the power supply is connected to a negative potential of the DC power supply). Accordingly, When the power factor is greater than 0, in corresponding multiple vector control cycles, the upper bridge arm of a phase with the greatest instantaneous value of the equivalent phase voltage is kept on, that is, the second transistor of the upper bridge arm is clamped to the positive potential of the DC power supply, to implement DPWM control, so as to reduce effective switching times of the second transistor of the upper bridge arm, thereby reducing switching losses of the upper bridge arm, and further reducing switching losses of the entire multi-phase full-bridge drive system. In this case, when a current of the phase flows from the motor to the bridge arm, the current will not flow through the second transistor in the upper bridge arm of the phase, and thus, in the corresponding vector control cycles, the upper bridge arm of the phase may not be kept on, that is, the second transistor in the upper bridge arm of the phase is not clamped to the positive potential of the DC power supply. Instead, in the corresponding multiple vector control cycles, switching is performed according to a CPWM method, thereby optimizing harmonic performance of the system. When the power factor is smaller than 0, in the corresponding multiple vector control cycles, the lower bridge arm of a phase with the smallest instantaneous value of the equivalent phase voltage is kept on, that is, the first transistor of the lower bridge arm of the phase is clamped to the negative potential of the DC power supply, to achieve DPWM control. In this case, the second transistor of the upper bridge arm remains off, thereby reducing switching times of the second transistor of the upper bridge arm, and thereby reducing switching losses of the upper bridge arm, and thus switching loss of the entire multi-phase full-bridge drive system is reduced. In this case, when a current of the phase flows from the motor to the bridge arm, the current will not flow through the second transistor in the upper bridge arm of the phase, and thus, in the corresponding vector control cycles, the lower bridge arm of the phase may not be kept on, that is, the first transistor in the lower bridge arm is not clamped to the negative potential of the DC power supply. Instead, in the corresponding multiple vector control cycles, switching is timely performed according to a CPWM method, thereby optimizing harmonic performance of the system.

The above discloses three-phase full-bridge drive systems using a variety of combinations of transistors and methods for driving a motor using the systems, including various embodiments described above in conjunction with the accompanying drawings. Regardless of the combination of the transistors used, the DPWM control method is used, which may reduce effective switching times of a transistor with greater switching loss, thereby reducing switching loss of the entire three-phase full-bridge drive system and improving efficiency of the system. In addition, the embodiments may also bring other beneficial effects due to specific performance of the transistors/switch devices in the combinations. For example, when a half-bridge circuit adopts a normally-on transistor and a normally-off transistor, a beneficial effect that the motor is caused to enter an active short-circuit state when the system loses control could be brought. When a half-bridge circuit adopts a combination of transistors/switching devices with different short-circuit withstand capability, additional beneficial effects could be brought, for example, the device with strong short-circuit withstand capability in each of the half-bridge circuits may reliably turn off a short-circuit current, avoiding damage to the switch device/semiconductor transistor with weak short-circuit withstand capability, thereby improving reliability of the entire drive system. In the case of some combinations of transistors/switching devices, such as the combination of a silicon carbide JFET and an IGBT, multiple beneficial technical effects as mentioned above could be brought at the same time. It should be noted that the present disclosure is not limited to the embodiments described in conjunction with the accompanying drawings, but is intended to include all variations and modifications thereof.

It should be noted that although the three-phase full-bridge drive system and the method for driving a motor using the three-phase full-bridge drive system are described in detail above in conjunction with the accompanying drawings, they are only provided for illustrative purposes and not for limitation. Instead, the multi-phase full-bridge drive system proposed in the present disclosure includes any multi-phase full-bridge drive system having at least three half-bridge circuits. Moreover, the method for driving a motor proposed in the present disclosure is also applicable to controlling any multi-phase full-bridge drive system having at least three half-bridge circuits to achieve a target multi-phase drive voltages for driving the motor. In addition, the multi-phase full-bridge drive system and the method for driving a motor according to the present disclosure are described above in conjunction with a variety of specific combinations of transistors above in the present disclosure. However, this is provided only for illustrative purposes and not for limitation. In fact, it is easy to understand that the drive system and drive method disclosed in the present disclosure may also include a variety of other different combinations of transistors and half-bridge and full-bridge circuits formed thereby. In addition, the motor mentioned in the present disclosure may be a synchronous motor or an asynchronous motor. The motor is a three-phase motor or a multi-phase motor with more phases. The motor has at least three lead terminals, each of which is connected to one corresponding half-bridge circuit. In addition, although the multi-phase full-bridge drive system (e.g., the three-phase full-bridge drive system) is described above in conjunction with driving motor, and some of the embodiments described above are particularly useful for driving a motor on an electric vehicle (e.g., making it enter an ASC state in the event of a fault), the multi-phase full-bridge drive system described in the present disclosure may also be used to drive other inductive loads, such as connecting to a power grid, etc. Moreover, when used for the other inductive loads, the following advantages could be brought as well: effective switching times of a transistor with greater switching loss are reduced, thereby reducing switching losses of the entire multi-phase full-bridge drive system and improving efficiency of the system.

It should be noted that, when a power factor is zero, the control process for driving a motor may be performed in accordance with the control strategies described above for a power factor greater than zero or a power factor less than zero.

It should be understood that, although terms such as “first” and “second” are used in the present disclosure to describe various devices, elements, parts or stages, these devices, elements, parts or stages should not be limited by these terms. These terms are only used to distinguish one device, element, part or stage from another device, element, part or stage.

Although the present disclosure has been described in connection with some embodiments, the present disclosure is not intended to be limited to the specific forms and details set forth herein. Instead, the scope of the present disclosure is limited only by the appended claims and their equivalents. In addition, although individual features may be included in different claims, these features may be combined. The order of features in the claims does not imply any particular order in which the features must work. Furthermore, in the claims, the word “comprising” does not exclude other elements, and the terms “a” and “an” does not exclude a plurality.

What is claimed is:

1. A multi-phase full-bridge drive system for driving a motor, comprising:
a multi-phase full-bridge circuit, comprising at least three identical half-bridge circuits wherein each of the half-bridge circuits comprises a first transistor and a second transistor, and switching loss of the first transistor is less than switching loss of the second transistor; and
a controller used to control the multi-phase full-bridge circuit to generate target multi-phase drive voltages for driving the motor, wherein the controller is configured to select a half-bridge circuit from the at least three half-bridge circuits based on a power factor of the motor and the target multi-phase drive voltages, and reduce effective switching times of the second transistor of the selected half-bridge circuit based on the power factor of the motor.

2. The multi-phase full-bridge drive system of claim 1, wherein a terminal for connecting to a power supply of the first transistor of each of the half-bridge circuits is connected to a positive potential of a DC power supply, and a terminal for connecting to the power supply of the second transistor of each of the half-bridge circuits is connected to a negative potential of the DC power supply, and wherein selecting a half-bridge circuit from the at least three half-bridge circuits based on the power factor of the motor and the target multi-phase drive voltages comprises:
in response to the power factor of the motor being greater than zero, selecting a half-bridge circuit associated with a phase with the smallest instantaneous voltage value in the target multi-phase drive voltages from the at least three half-bridge circuits; and
in response to the power factor of the motor being smaller than zero, selecting a half-bridge circuit associated with a phase with the greatest instantaneous voltage value in the target multi-phase drive voltages from the at least three half-bridge circuits.

3. The multi-phase full-bridge drive system of claim 2, wherein reducing the effective switching times of the second transistor of the selected half-bridge circuit based on the power factor of the motor comprises:
the controller controls the first transistor or the second transistor of the selected half-bridge circuit according to the power factor of the motor so that the first transistor or the second transistor remains in an ON state.

4. The multi-phase full-bridge drive system of claim 3, wherein:
in response to the power factor of the motor being greater than zero, the second transistor of the selected half-bridge circuit is controlled so that the second transistor remains in an ON state; or
in response to the power factor of the motor being smaller than zero, the first transistor of the selected half-bridge circuit is controlled so that the first transistor remains in an ON state.

5. The multi-phase full-bridge drive system of claim 2, wherein reducing the effective switching times of the second transistor of the selected half-bridge circuit based on the power factor of the motor comprises:
the controller further determines a direction in which current flows, and keeps the first transistor or the second transistor of the selected half-bridge in an ON state or controls the first transistor or the second transistor of the selected half-bridge circuit through CPWM, according to both the power factor of the motor and the direction in which the current flows.

6. The multi-phase full-bridge drive system of claim 5, wherein:
in response to the power factor of the motor being greater than zero:
in response to the current flowing from the motor to the DC power supply, the second transistor of the selected half-bridge circuit is controlled so that the second transistor remains in an ON state; or
in response to the current flowing from the DC power supply to the motor, the first transistor and the second transistor of the selected half-bridge circuit are controlled according to a CPWM control method to perform switching actions, or
in response to the power factor of the motor being smaller than zero:
in response to the current flowing from the motor to the DC power supply, the first transistor of the selected half-bridge circuit is controlled so that the first transistor remains in an ON state; or
in response to the current flowing from the DC power supply to the motor, the first transistor and the second transistor of the selected half-bridge circuit are controlled according to the CPWM control method to perform switching actions.

7. The multi-phase full-bridge drive system of claim 1, wherein the first transistor is selected from a group including a silicon carbide JFET, a gallium nitride HEMT, an IGBT and a silicon carbide MOSFET, and the second transistor is selected from a group including an IGBT, a silicon carbide MOSFET and a silicon carbide JFET.

8. The multi-phase full-bridge drive system of claim 1, wherein short-circuit withstand capability of the first transistor is weaker than short-circuit withstand capability of the second transistor.

9. The multi-phase full-bridge drive system of claim 1, wherein the first transistor and the second transistor are of a same transistor type, or the first transistor and the second transistor are of different device types, wherein the controller is further configured to:
in response to the first transistor and the second transistor are of a same transistor type, configure the first transistor and the second transistor of each of the half-bridge circuits, respectively, by adjusting transistor driving parts connected to control terminals of the first transistor and the second transistor of each of the half-bridge circuits, so that the switching loss of the first transistor is less than the switching loss of the second transistor and/or short-circuit withstand capability of the first transistor is weaker than short-circuit withstand capability of the second transistor.

10. The multi-phase full-bridge drive system of claim 8, wherein the first transistor is a MOSFET or a silicon carbide JFET, and the second transistor is an IGBT.

11. The multi-phase full-bridge drive system of claim 1, wherein the first transistor is a normally-on transistor and the second transistor is a normally-off transistor, or the first transistor is a normally-off transistor and the second transistor is a normally-on transistor.

12. The multi-phase full-bridge drive system of claim 11, wherein in response to the three-phase full-bridge drive system being out of control, the normally-on transistors of all the half-bridge circuits are turned on simultaneously to put the motor into an active short-circuit state.

13. The multi-phase full-bridge drive system of claim 11, wherein the first transistor is a silicon carbide JFET or a gallium nitride HEMT, and the second transistor is an IGBT.

14. The multi-phase full-bridge drive system of claim 1, wherein each of the half-bridge circuits further comprises a first diode connected to the first transistor in anti-parallel, and/or a second diode connected to the second transistor in anti-parallel.

15. The multi-phase full-bridge drive system of claim 14, wherein the first diode and the second diode are selected from a group including a silicon carbide diode with a Schottky structure and a fast recovery diode.

16. A method for driving a motor, comprising:
configuring a multi-phase full-bridge circuit such that the multi-phase full-bridge circuit comprises at least three identical half-bridge circuits, wherein each of the half-bridge circuits comprises a first transistor and a second transistor, and switching loss of the first transistor is less than switching loss of the second transistor; and
controlling, via a controller, the multi-phase full-bridge circuit to generate target multi-phase drive voltages for driving the motor, comprising: selecting, via the controller, a half-bridge circuit from the at least three half-bridge circuits based on a power factor of the motor and the target multi-phase drive voltages, and reduce effective switching times of the second transistor of the selected half-bridge circuit based on the power factor of the motor.

17. The method of claim 16, wherein a terminal for connecting to a power supply of the first transistor of each of the half-bridge circuits is connected to a positive potential of a DC power supply, and a terminal for connecting to the power supply of the second transistor of each of the half-bridge circuits is connected to a negative potential of the DC power supply, and wherein selecting a half-bridge circuit from the at least three half-bridge circuits based on the power factor of the motor and the target multi-phase drive voltages comprises:
in response to the power factor of the motor being greater than zero, selecting a half-bridge circuit associated with a phase with the smallest instantaneous voltage value in the target multi-phase drive voltages from the at least three half-bridge circuits; and
in response to the power factor of the motor being smaller than zero, selecting a half-bridge circuit associated with a phase with the greatest instantaneous voltage value in the target multi-phase drive voltages from the at least three half-bridge circuits.

18. The method of claim 17, wherein reducing the effective switching times of the second transistor of the selected half-bridge circuit based on the power factor of the motor comprises:
the controller controls the first transistor or the second transistor of the selected half-bridge circuit according to the power factor of the motor so that the first transistor or the second transistor is in an ON state.

19. The method of claim 18, wherein:
in response to the power factor of the motor being greater than zero, the second transistor of the selected half-bridge circuit is controlled so that the second transistor remains in an ON state; or
in response to the power factor of the motor being smaller than zero, the first transistor of the selected half-bridge circuit is controlled so that the first transistor remains in an ON state.

20. The method of claim 17, wherein reducing the effective switching times of the second transistor of the selected half-bridge circuit based on the power factor of the motor comprises:
the controller further determines a direction in which current flows, and keeps the first transistor or the second transistor of the selected half-bridge in an ON state or controls the first transistor or the second transistor of the selected half-bridge circuit through CPWM, according to the power factor of the motor and the direction in which the current flows.

21. The method of claim 20, wherein:
in response to the power factor of the motor being greater than zero:
in response to the current flowing from the motor to the DC power supply, the second transistor of the selected half-bridge circuit is controlled so that the second transistor remains in an ON state; or
in response to the current flowing from the DC power supply to the motor, the first transistor and the second transistor of the selected half-bridge circuit are controlled according to a CPWM control method to perform switching actions, or
in response to the power factor of the motor being smaller than zero:
in response to the current flowing from the motor to the DC power supply, the first transistor of the selected half-bridge circuit is controlled so that the first transistor remains in an ON state; or
in response to the current flowing from the DC power supply to the motor, the first transistor and the second transistor of the selected half-bridge circuit are controlled according to the CPWM control method to perform switching actions.

22. The method of claim 16, wherein the first transistor is selected from a group including a silicon carbide JFET, a gallium nitride HEMT, an IGBT and a silicon carbide MOSFET, and the second transistor is selected from a group including an IGBT, a silicon carbide MOSFET and a silicon carbide JFET.

23. The method of claim 16, wherein short-circuit withstand capability of the first transistor is weaker than short-circuit withstand capability of the second transistor.

24. The method of claim 16, wherein the first transistor and the second transistor are of a same transistor type, or the first transistor and the second transistor are of different device types, wherein the method further comprises:
in response to the first transistor and the second transistor are of a same transistor type, configuring, via the controller, the first transistor and the second transistor of each of the half-bridge circuits, respectively, by adjusting transistor driving parts connected to control terminals of the first transistor and the second transistor of each of the half-bridge circuit, so that the switching loss of the first transistor is less than the switching loss of the second transistor and/or short-circuit withstand capability of the first transistor is weaker than short-circuit withstand capability of the second transistor,.

25. The method of claim 23, wherein the first transistor is a MOSFET or a silicon carbide JFET, and the second transistor is an IGBT.

26. The method of claim 16, wherein the first transistor is a normally-on transistor and the second transistor is a normally-off transistor, or the first transistor is a normally-off transistor and the second transistor is a normally-on transistor.

27. The method of claim 26, wherein the method further comprises: in response to the three-phase full-bridge drive system being out of control, the normally-on transistors of all the half-bridge circuits are turned on simultaneously to put the motor into an active short-circuit state.

28. The method of claim 26, wherein the first transistor is a silicon carbide JFET or a gallium nitride HEMT, and the second transistor is an IGBT.

29. The method of claim 16, wherein each of the half-bridge circuits further comprises a first diode connected to the first transistor in anti-parallel, and/or a second diode connected to the second transistor in anti-parallel.

30. The method of claim 29, wherein the first diode and the second diode are selected from a group including a silicon carbide diode with a Schottky structure and a fast recovery diode.
